(19) United States
(12) Patent Application Publication
(10) Pub. No.: US 2007/0199582 A1
(43) Pub. Date: Aug. 30, 2007

(54) Water Supply Apparatus And Cleaning System For Cleaning The Water Supply Apparatus

(76) Inventor: Arie Kroon, Bergen (NL)

Correspondence Address: ALTERA LAW GROUP, LLC, 6500 CITY WEST PARKWAY, SUITE 100, MINNEAPOLIS, MN, 55344-7704, US

(21) Appl. No.: 10/579,086

(22) PCT Filed: Nov. 15, 2004
(86) PCT No.: PCT/NL04/00799

§ 371 Date: Apr. 10, 2007

(30) Foreign Application Priority Data
Nov. 14, 2003 (NL) 1024787

(51) Int. Cl. B08B 3/00

(52) U.S. Cl. 134/56 R; 134/109; 134/110; 134/58 R

(57) ABSTRACT

A cleaning system designed for cleaning a water supply apparatus which is provided with: a tap water inlet (2); a mineral dosing ubtil unit (18) with the aid of which, on the basis of tap water, mineral water can be generated; water processing means and a control unit (24) designed for controlling at least a part of the water processing means according to a predetermined water processing program for the purpose of presenting mineral water, the cleaning system being provided with at least one cleaning agent vessel (H) from which, in use, cleaning agent can be supplied, directly or indirectly,to the water supply apparatus, wherein the cleaning system is provided with a cleaning system control unit designed for controlling at least a part of the water processing means according to a predetermined cleaning program for the purpose of a cleaning at least a part of the water processing means.

The invention relates to a cleaning system designed for cleaning a water supply apparatus which is provided with: a tap water inlet; a mineral dosing unit with the aid of which, on the basis of tap water, mineral water can be generated; water processing means and a control unit designed for controlling at least a part of the water processing means according to a predetermined water processing program, for the purpose of presenting mineral water, the cleaning system being provided with at least one cleaning agent vessel from which, in use, cleaning agent can be supplied, directly or indirectly, to the water supply apparatus.

The invention also relates to an assembly of a water supply apparatus and a cleaning system for cleaning the water supply apparatus, the water supply apparatus-being provided with: a tap water inlet; a mineral dosing unit with the aid of which, on the basis of tap water, mineral water can be generated, and water processing means.

Further, the invention relates to a cleaning system suitable for cleaning an assembly according to any of the above-mentioned assemblies.

In addition, the invention relates to a method for cleaning a water supply apparatus which is provided with: a tap water inlet; water processing means with the aid of which, one the basis of tap water, mineral water can be generated; and at least one water dispensing outlet.

Finally, the invention relates to a assembly of a water supply apparatus and a cleaning system for cleaning the water supply apparatus, the water supply apparatus being provided with: a tap water inlet; a mineral dosing unit with the aid of which, on the basis of tap water, mineral water can be generated; and water processing means, the cleaning system being provided with at least one cleaning agent vessel from which, in use, cleaning agent can be supplied, directly or indirectly, to the water supply apparatus.

An example of a water supply apparatus according to an assembly as indicated hereinabove, is described in the international patent application WO 03/050045. In this case, the water processing means comprise: a first storage vessel which is filled, in use, with water to which minerals have been added. The first storage vessel can be provided with, for instance, a cooling unit for cooling this first storage vessel. The water processing means can also comprise a fluid connection between the tap water inlet and the first storage vessel. The water processing means can also comprise a filter included in the first fluid connection. During use, such a filter can filter the tap water. The water supply apparatus can be provided with a second storage vessel filled, in use, with minerals. Often, this second storage vessel will be provided with a dosing unit for dispensing, in a dosed manner, minerals from the second storage vessel to the first storage vessel. It is possible that the water processing means comprise a third storage vessel. This third storage vessel will, in use, also be filled with water to which minerals have been added. In the following, the term mineral water refers to water to which minerals have been added.

It is possible that the water processing means also comprise a second fluid connection between the first storage vessel and the third storage vessel for conveying mineral water from the first storage vessel to the third storage vessel. Further, the water processing means can comprise a water-dispensing outlet for dispensing mineral water from the third storage vessel and/or the first storage vessel. It is also possible that the water supply apparatus is further provided with at least a first recirculation system for discharging mineral water from the third storage vessel and for, then, returning the discharged mineral water to the third storage vessel. The water processing means can be understood to be means which, in the water supply apparatus, come into direct contact with the water which is suitable, or is made suitable for consumption.

The water supply apparatus can also include conduits, pumps and sealing valves. These, too, can be understood to be water processing means, when the water which is made suitable for consumption or has been made suitable for consumption contacts the inner walls of such parts.

To prevent, in particular, the growth of microbes and algae on surfaces, the water in the water supply apparatus must be in motion. Various pumps and the recirculation circuit are parts of the water processing means ensuring that the water is in motion regularly.

One elaboration of a water supply apparatus as described in the above mentioned international application can be provided with a control unit designed for controlling at least a part of the water processing means according to a predetermined water processing program. For instance, it is possible that the water is recirculated when no water is taken from the water supply apparatus for a considerable period of time or, conversely, when mineral water is taken from the water supply apparatus and new mineral water is to be generated on the basis of tap water.

Due to the presence of the control unit, the water supply apparatus can be very simple in use. For instance, after mineral water has been taken by a user, automatically, new mineral water can be generated by the apparatus. It is possible that with the aid of, for instance, a float the amount of water still present in one of the storage vessels is established and that with a predetermined, minimum, amount of mineral water still present, the control unit controls the processing means on the basis of the signal of the float such that fresh tap water flows through the tap water inlet into the water supply apparatus and a new amount of mineral water is prepared. In this manner, the water supply apparatus can, to a certain extent, clean the water processing means by automatically flushing water, at fixed times, or after a period in which no use has been made of the water supply apparatus, through the water processing means and, optionally, discharging it whereupon, automatically, the water supply apparatus can, once more, allow water via the tap water inlet into the water supply apparatus for generating fresh mineral water with the aid of the water processing means.

The water supply apparatus comprising a control unit designed for controlling at least a part of the water processing means according to a predetermined water processing program, is, as indicated hereinabove, designed so as to be self-cleaning to a certain extent. However, it is not precluded that growth of microbes and/or algae still takes place within the water processing means at positions where moving water can not easily prevent the growth of algae and/or microbes, for instance because moving water, when flowing through the water processing means, hardly reaches these positions. Therefore, it appears advisable to add a cleaning agent to the water supply apparatus after a particular period of time, so that due to the presence of the cleaning agent in the water supply apparatus, the presence of any microbes, growth of algae and/or contamination in the water processing means can be reduced. Further, the cleaning agent can be such that growth of bacteria in the water supply apparatus is prevented too and/or can be such that bacteria are killed. In that case, disinfection of the water supply apparatus is involved, such as it will take place, as a rule, directly after assembly of the water supply apparatus. To this end, the water supply apparatus will typically be used as part of an assembly comprising a water supply apparatus and a cleaning system for cleaning the water supply apparatus. In this connection, a cleaning system comprises at least one cleaning agent vessel from which, in use, cleaning agent can be added, directly or indirectly, to the water supply apparatus.

A problem is that the water supply apparatus comprises a control unit designed for controlling at least a part of the water processing means according to a predetermined program of a first type. As has been set forth hereinabove, this controlling is directed to keep the water in motion and to react to the decrease of mineral water by a user. Although it may promote the cleaning agent to spread relatively rapidly through the water processing means so that cleaning agent can arrive at virtually all positions which come into contact with the water, it also causes the cleaning agent to be relatively difficulty driven from the water supply apparatus, once it has been included therein.

The problem that the cleaning agent can be driven from the water supply apparatus relatively difficultly can, for that matter, also occur in water supply apparatus in which no circulation of the water takes place.

The invention intends to meet at least one drawback of the assembly as further described hereinabove.

This object of the invention is achieved with an assembly according to the invention which is characterized in that the cleaning system is provided with a cleaning system control unit designed for controlling at least a part of the water processing means according to a predetermined cleaning program for the purpose of cleaning at least a part of the water processing means. In this connection, cleaning is understood to mean reducing an amount of contamination, comprising for instance, microbes and growth of algae, present in the water supply apparatus, and reducing an amount of cleaning agent present in the water supply apparatus. As the cleaning system according to the invention comprises a cleaning system control unit, it is possible to have the water processing means function differently from the manner if functions when, for instance, mineral water is being generated on the basis of tap water. Controlling the water processing means according to a predetermined cleaning program can, in an initial cleaning phase, for instance be directed to spreading a cleaning agent such that the water processing means come into contact with the cleaning agent. After the initial phase, controlling the water processing means can be directed to diluting the cleaning agent such that the cleaning agent is virtually no longer present, at least can only be present in a concentration lower than a predetermined concentration of which it has been established that it is not detrimental to the health when water with such a concentration is drunk and/or will have no noticeable taste effect on the mineral water made suitable for consumption. An example of such a predetermined cleaning program will be described further.

Preferably, it holds that the cleaning system control unit can be connected with the control unit of such a water supply apparatus. This offers the advantage that the water supply apparatus needs not be provided with direct connections such as, for instance, electric wiring between the water processing means and the cleaning system control unit. The cleaning system control unit can simply be connected with the control unit of the water supply apparatus and utilize the connections between the water processing means and the control unit of the water supply apparatus.

It is possible that the first and the second control unit are integrally connected with each other. This is also understood to include a situation in which one control unit is involved, designed for carrying out the water processing program and, if desired, for carrying out the cleaning program.

In a special embodiment it holds that the cleaning system is also provided with a water inlet for taking in water. For instance, the cleaning system cannot only supply a cleaning agent to the water supply apparatus, but also, on the basis of water, carry out cleaning activities as will be discussed hereinbelow.

Further, it can hold that the water inlet can be connected or has been connected with the water supply apparatus such that, in use, water can flow from the water supply apparatus into the water inlet. This offers the advantage that any water that may be present in the water supply apparatus can be used for diluting the cleaning agent. This can offer an advantage in particular when a position where the water supply apparatus is arranged is provided with only one supply source for tap water. It is, for instance, possible that the water conduit inlet is provided with a branching, provided or not provided with a valve, with which it is possible to have tap water flow into the water inlet of the cleaning system.

In particular, it holds that downstream of the tap water inlet, the water inlet of the cleaning system can be connected, or has been connected, with the water supply apparatus. As a rule, a tap water inlet will be shielded from vision and be placed on a rear side of the water supply apparatus, in use often against a side placed against a wall. When the cleaning system can be connected or has been connected with the water supply apparatus downstream of the tap water inlet, this offers the possibility that connection of the water inlet of the cleaning system to the water supply apparatus can take place in a simple manner. The fact is that the water inlet can be connected with the water supply apparatus at a position which can be reached without the water supply apparatus having to be moved.

Further, it may hold that the cleaning system is provided with at least one cleaning agent outlet which can be connected, or has been connected, with the water supply apparatus for adding, during use, cleaning agent to the water supply apparatus. This offers the advantage that the cleaning agent can arrive from the cleaning system directly into the water supply apparatus. Preferably, it then holds that upstream of the water processing means, at least one cleaning agent outlet of the cleaning system can be connected, or has been connected, with the water supply apparatus. This offers the advantage that it is also possible to place the cleaning agent vessel, as a part of the cleaning system, between the tap water inlet and the water processing means of the water supply apparatus. As a result, a highly efficient and rapid manner of cleaning the water supply apparatus is possible as the tap water is directly provided by the cleaning system with the cleaning agent and then flows through the water processing means for the purpose of cleaning the water processing means.

It is possible that the cleaning system control unit is also designed for controlling the cleaning system.

In a special embodiment it holds, that the cleaning system is also designed for cleaning such a water supply apparatus, which is also provided with a first terminal for connection with an electric energy source and with a second terminal with which the cleaning system can be connected so as to be connected with an electric energy source as well. This offers the advantage that the cleaning system needs not be provided with a long electric cord for connection with an electric energy source. A relatively short cord can suffice. Further, this may mean that the position of the water supply apparatus needs not be changed for, for instance, connecting the cleaning system directly with the electricity network, a terminal of which may be located in the wall behind the water supply apparatus.

Preferably, it holds that the cleaning system is provided with at least one filter holder in which, with the cleaning system in use, at least one filter intended for the water supply apparatus can be included for, for instance, cleaning the filter. This offers the possibility that the filter can undergo a special treatment in cleaning system. This can for instance entail allowing water to flow through the filter in a direction opposite to the direction of the water through the filter when the filter is placed in the water supply apparatus. Furthermore, this can entail exposing the filter to high pressure from a flow of water for removing filth from the filter. This can take place with a new filter but also with a used filter.

In particular it holds that the cleaning system is provided with a water purification device and a purified-water outlet for purifying water or discharging purified water, respectively. This has the advantage that the cleaning system can also prepare purified water with which the water supply apparatus can be filled for the purpose of preparing the water supply apparatus for use. The water supply apparatus can also be flushed with purified water.

The invention is presently elucidated with reference to a drawing. In the drawing:

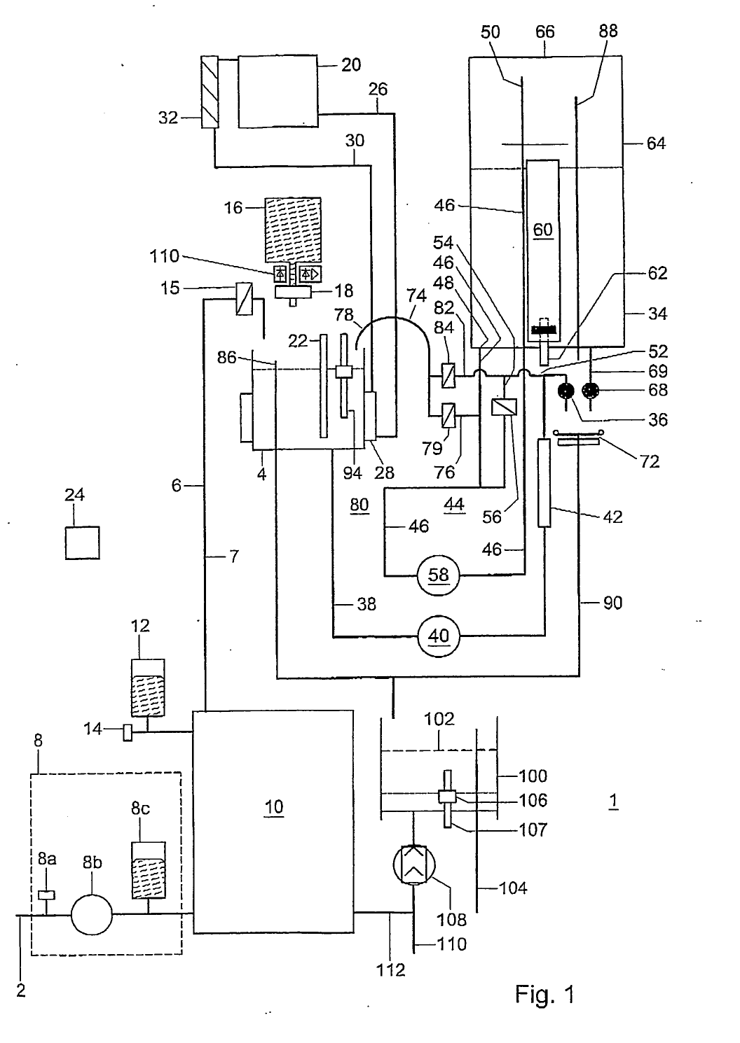

FIG. 1 schematically shows a first possible embodiment of a water supply apparatus of an assembly according to be invention;

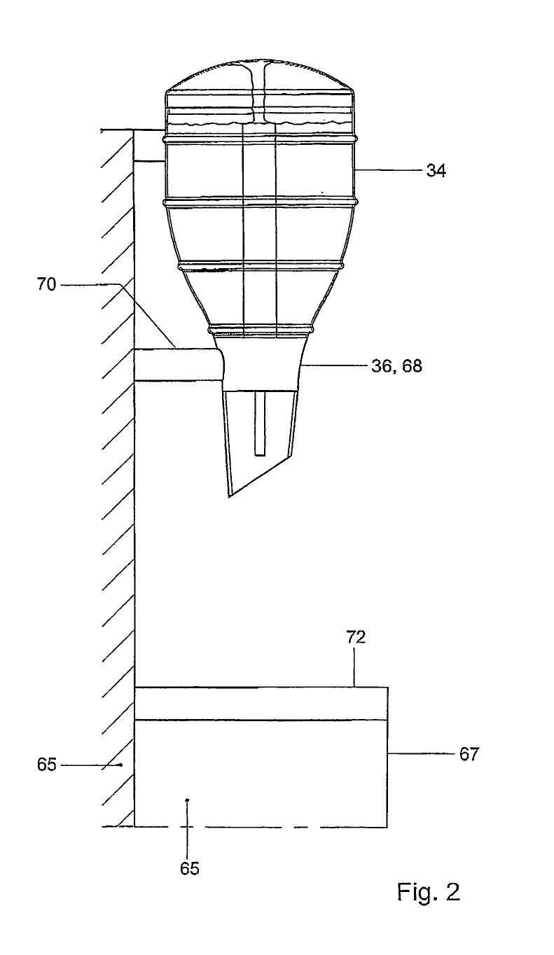

FIG. 2 shows a view of a possible embodiment of a water supply apparatus of the assembly according to the invention;

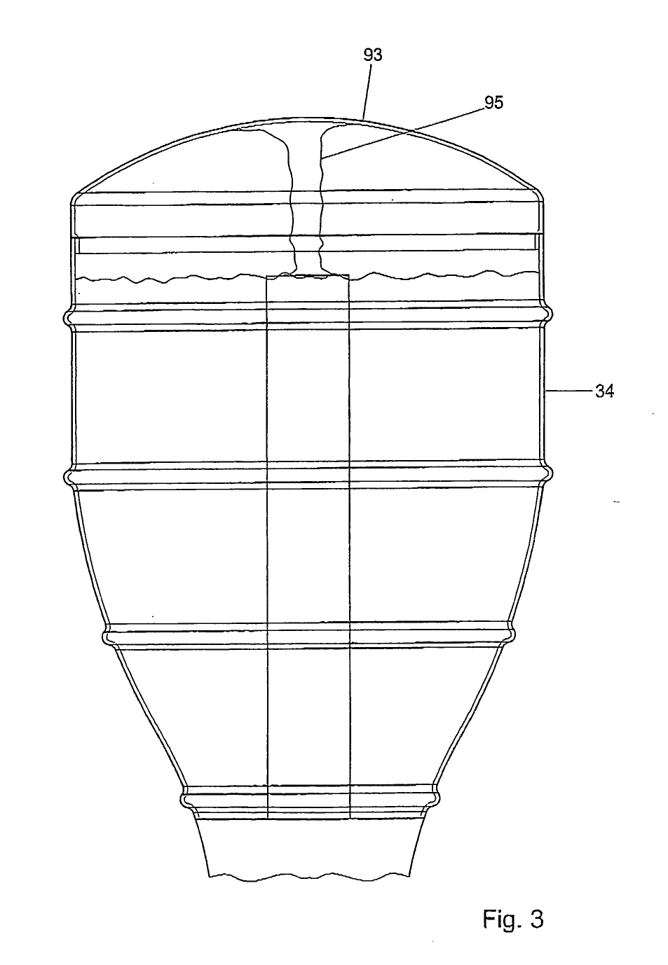

FIG. 3 shows in detail the third storage vessel of the apparatus according to FIG. 2;

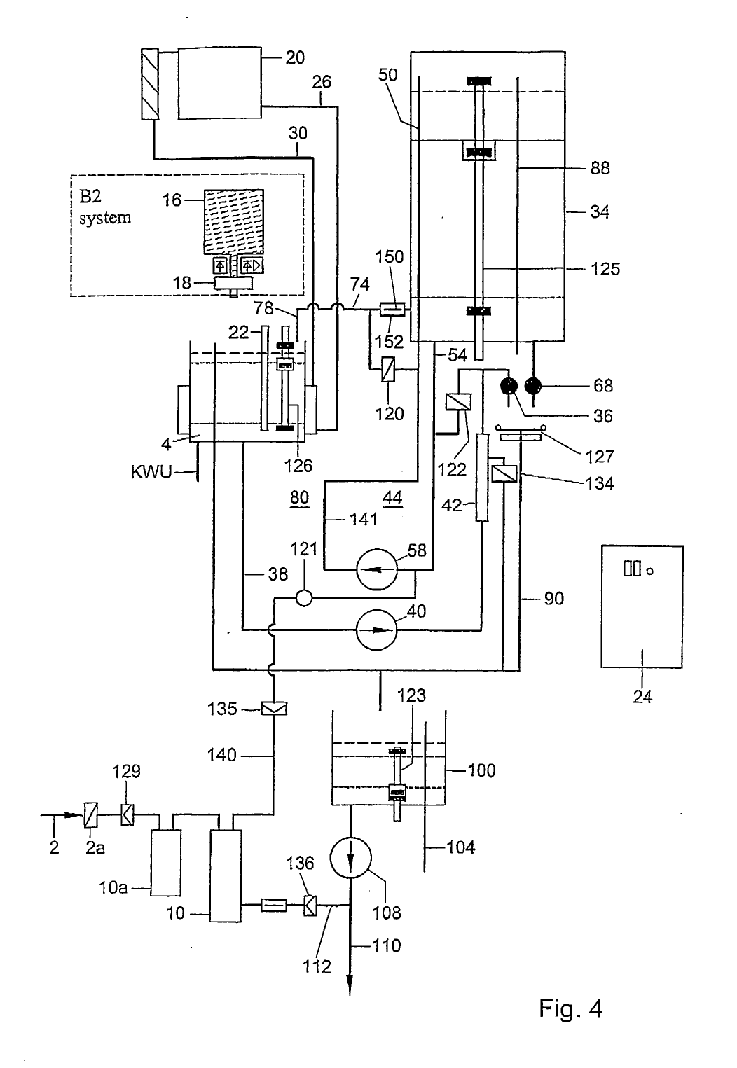

FIG. 4 schematically shows a second possible embodiment of a water supply apparatus of an assembly according to the invention;

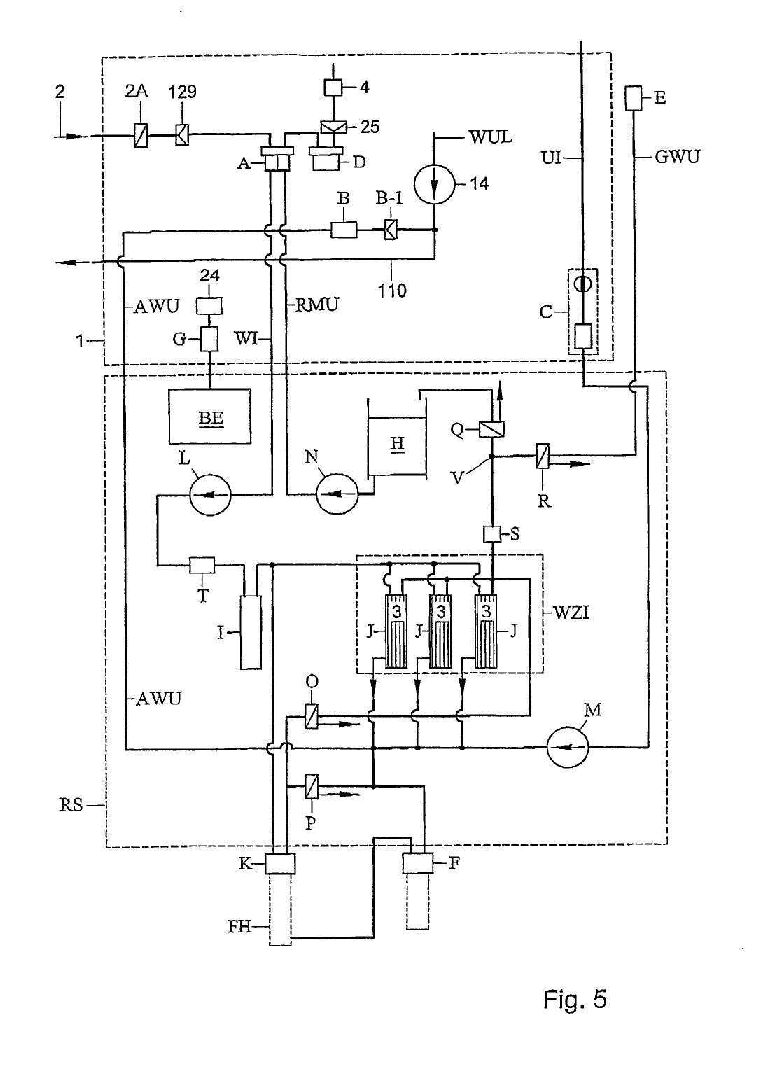

FIG. 5 shows an embodiment of a cleaning system of an assembly according to the invention.

In the drawing, identical parts are often provided with identical reference signs.

In FIG. 1, reference numeral 1 denotes a first possible embodiment of the water supply apparatus for presenting mineral water suitable for consumption. In the following, the water supply apparatus is also simply indicated with apparatus. The apparatus is provided with a tap water inlet 2 which, in use, can be connected with an open tap. In this specification, the tap water inlet is sometimes also called water supply inlet 2. The apparatus is further provided with a first storage vessel 4 which, in use, is filled with mineral water. Further, the apparatus is provided with a first fluid connection 6 between the inlet 2 and the first storage vessel 4. The first fluid connection 6 comprises a conduit 7 which extends from the inlet 2 to the first storage vessel 4. Optionally, the fluid connection 6 includes a pressure regulating unit 8 and a filter 10. If the tap water pre-pressure is high enough, the pressure-regulating unit is not required. An inlet of the pressure-regulating unit 8 is connected with the tap water inlet 2. Further, an outlet of the pressure-regulating unit 8 is connected with an inlet of the filter 10. The pressure-regulating unit 8 is for instance provided with a pressure switch 8a, a pump 8b and an expansion vessel 8c. When the pressure switch 8a is turned on, the pump 8b generates a pressure of 25 Psi (≈172 kPa=172.103 kg/(m.s²)), when the pressure switch 8a is turned off, it generates a pressure of 35 Psi (≈241 kPa=241.103 kg/(m.s²)).

Further, the filter 10 may be connected with an expansion vessel 12 and a pressure switch 14.

The filter 10 is arranged for filtering tap water which flows from the tap water inlet 2 via the fluid connection 6 to the first storage vessel 4. The fluid connection 6 further includes a valve 15 for opening and releasing the fluid connection 6.

The apparatus is further provided with a second storage vessel 16 which, in use, is filled with minerals. The storage vessel 16 may then, for instance, be filled with a viscous mineral concentrate or with minerals in powder (dry) form. The apparatus further comprises a dosing unit 18 for dispensing, in a dosed manner, minerals from the second storage vessel 16 to the first storage vessel 4. The dosing unit 18 may, for instance, be designed as described in Netherlands patent application 1012395.

The apparatus is further provided with a cooling unit 20 for cooling the first storage vessel 4. Therefore, in this specification, first storing vessel 4 is also indicated with cold-water vessel. In the first storage vessel 4, a temperature sensor 22 is included which measures the temperature of the mineral water contained in the storage vessel 4. The measured temperature is transmitted to a check unit 24. In this specification, the check unit 24 is also called control unit 24. The control unit 24 controls, on the basis of the measured temperature, the cooling unit in order that it regulates the mineral water contained in the first storage vessel 4 to a predetermined cooled temperature. In general, this temperature will be lower than room temperature, for instance 4-16 degrees. To this end, the cooling unit 20 allows a cooling liquid to flow via a conduit 26 to a heat exchanger 28 which heat exchanger is connected with the first storage vessel 4. The cooling liquid flows through the heat exchanger 28 for cooling the mineral water contained in the first storage vessel 4. The cooling liquid is then returned via a conduit 30 to the cooling unit 20. The apparatus is further provided with a ventilator 32 or a static cooler such as, for instance, a peltier element for cooling the cooling liquid in the conduit 30 and for cooling the cooling unit 20. In particular, the second storage vessel 16 can also be cooled by means of the cooling unit 20 or by means of another cooling unit (not shown).

The apparatus is further provided with a third storage vessel 23 which, in use, is also filled with mineral water. The apparatus is provided with a manually operable first outlet 36 which is connected with the first storage vessel 4 via a conduit 38. The conduit 38 includes a pump 40 and a filter 42, in particular a membrane filter for removing viruses or bacteria. The apparatus is further provided with a first recirculation system 44 for discharging mineral water from the third storage vessel and for, then, supplying discharged mineral water to the third storage vessel again. To this end, the recirculation system 44 comprises a conduit system 46 of which an inlet 48 is situated at a bottom of the third storage vessel 34 and of which a recirculation outlet 50 is situated near an upper side of the third storage vessel 34. The conduit 38 is connected, downstream of the membrane filter 42, with the conduit system 46 by means of a conduit 52 and a conduit 54 via a valve 56. When the outlet 36 is closed and the valve 56 is open, the conduits 38, 52, 54 and a part of the conduit system 46 thus form a second fluid connection between the first storage vessel and the third storage vessel for conveying mineral water from the first storage vessel to the third storage vessel. It therefore holds that the second fluid connection extends at least in part through at least a part of the first recirculation system. This mineral water is then pumped by the pump 40 from the first storage vessel 4 to the recirculation system 44. The conduit system 46 of the recirculation system includes a pump 58 which then pumps the mineral water further so that this is pumped via the recirculation outlet 50 into the third storage vessel 34. The third storage vessel 34 is further also provided with a float 60 which energizes a switch 62 when the level of the mineral water in the third storage vessel 34 exceeds a predetermined value. Preferably, the float can move the switch in a high position at a high water level, to a middle position at a desired level of the water and to a low position at a low level of the water.

A wall 64 of the storage vessel is of at least partly transparent design. When the valve 56 is closed and the pump 58 is in operation, the water will be recirculated by way of the recirculation system 44, while this water squirts from the recirculation outlet 50 against an inner wall 66 of the wall 64 of the third storage vessel. In this example, the mineral water squirts from the recirculation outlet 50 against the transparent part of the wall 64 of the third storage vessel 34. As can be seen in FIG. 2, it holds in this example, that the apparatus is further provided with a housing 65 in which all parts mentioned are included, with the exception the third storage vessel 34 and the outlet 36. The first storage vessel 4, the second storage vessel 16, the pressure regulating unit 8 and the filter 10, the filter 42, the pump 58 et cetera are therefore included in the housing 65 and are shielded from vision. In this example it further holds that the third storage vessel 34 (see FIG. 3) is of spherical design on its upper side, the transparent part of the wall 64 comprising at least a part of the spherical part. In this example it holds that the entire storage vessel 34 is of transparent design and is situated completely outside the housing. In this example, the conduit 36 forms a third fluid connection between the first storage vessel and the first outlet 36 for dispensing cooled mineral water from the first storage vessel. The apparatus is further provided with a second outlet 68 for dispensing mineral water from the third storage vessel 34 via a conduit 69 forming a fourth fluid connection. In this example, the first outlet 36 and the second outlet 68 are placed near each other, such that from both outlets, mineral water can be supplied to a holder such as a beaker or cup without requiring displacement of the holder.

As shown in FIG. 2, the first and second outlet 36, 38 are placed below the third storage vessel 34 so that the user obtains the impression that the water flowing out of the first outlet 36 comes from the third storage vessel 34.

The third storage vessel 34 hangs, by means of a support 70 and an upstanding wall 71, above a platform 72 of the housing 67. The third fluid connection connecting the first storage vessel 4 with the first outlet 36 extends through the support 70. Thus, this is invisible to the user. This likewise applies to the conduits 48 and 52, that is to say, to the first recirculation system and the second fluid connection. Furthermore, the third fluid connection and the conduits 46, 52 extend further behind or through the upstanding wall 71 to the housing 67.

The apparatus is further provided with a fifth fluid connection between the third storage vessel 34 and the first storage vessel 4 for conveying mineral water from the third storage vessel back to first storage vessel. In this example, this fifth fluid connection comprises a conduit 74 of which an inlet 76 is connected with the recirculation system 44 and of which an outlet 78 discharges into the first storage vessel, and a part of the conduit system 46. The conduit 74 further includes a valve 79. In fact, the conduit 74 forms a sixth fluid connection extending from the first recirculation system 44 to the first storage vessel 4. By opening the valve 79, the mineral water can be returned from the third storage vessel 34 to the first storage vessel 4. The fifth fluid connection is therefore also shielded from vision, as described for the third fluid connection. The apparatus is further provided with at least a second recirculation system 80 for discharging mineral water from the first storage vessel and for then returning the discharged mineral water to the first storage vessel again. In this example, this second recirculation system is formed by the conduit 38, the conduit 52, and a conduit 82 which connects the conduit 52 and the conduit 74 with each other. It therefore holds that the second fluid connection extends through at least a part of the second recirculation system. The conduit 82 includes a valve 84. When the valve 84 is open, the water is recirculated via the conduits mentioned, that is to say, by means of the conduit 38, it flows out of the first storage vessel 4, and is supplied to the first storage vessel again via the conduits 52, 82 and 74. The recirculation system 80 comprises the filter 42 to prevent microbial and/or growth of algae (lower plants) in the mineral water supplies. Microbial is then protozoa, bacteria or viruses.

Here, filter 42 is in the recirculation system 80, but could also be present in the recirculation system 44 or parallel to conduit 46, a part being filtered continuously. This results in different methods for cleaning the water. Either periodically over recirculation system 80 or continuously over recirculation system 44.

The first storage vessel 4 is further provided with an overflow 86 for discharging mineral water from the first vessel when the level of the mineral water in the first storage vessel exceeds a first predetermined value. Furthermore, the third storage vessel is provided with an overflow 88 for discharging mineral water from the third storage vessel when the level of the mineral water in the third storage vessel exceeds a second predetermined value. The second overflow discharges into the platform 72. The platform 72 is connected with a discharge channel 90 for discharging (for instance spilt) mineral water from the platform. Also, in this manner, mineral water flowing out of the third storage vessel 34 because the mineral water level exceeds the second predetermined value, is discharged via the platform 72 via the conduit 90.

The control device 24 controls each the valves and pumps mentioned and the cooling unit 20.

In this example, it therefore holds that each fluid connection that extends from the housing 67 to the third storage vessel 34 or the first outlet 36 is shielded from vision and that the first storage vessel the second storage vessel, the cooling unit and the dosing unit are shielded from vision.

The hitherto described apparatus operates as follows. Tap water is supplied to the filter via the optional pressure unit 8. The filter 10 is, for instance, arranged for filtering from the tap water sediment, dirt, rust, odorants and flavourings, minerals and/or salts and/or microorganisms. This filter may also comprise a reversed osmosis membrane, an ion exchanger and/or a distillation device. This filter may likewise comprise a carbon filter. As a result, organic and inorganic ingredients or components are removed.

The thus filtered water is supplied via the first fluid connection 6 to the first storage vessel 4 when the valve 15 is open. As a result, the water level in the first storage vessel will rise. The storage vessel is further provided with a float 94 with a switch that indicates when a desired level in the first storage vessel 4 has been reached. The switches communicate with the control unit 24 which, subsequently or simultaneously in the proper ratio closes the valve 15 and switches the pump 8b off. Then, the control device 24 controls the dosing device 18 for adding minerals to the filtered water. Thus, mineral water is formed in the vessel 4. To properly mix the minerals with the mineral water, the control device 24 ensures that the mineral water is recirculated in the first storage vessel 4 via the second recirculation system 80. To this end, the valves 56 and 79 will be closed and the valve 84 is open. Furthermore, the pump 40 will be in operation. Naturally, the mixing of the water with the minerals can also be carried out by means of a stirrer included in the first storage vessel 4. A static mixer may also be used. It is also conceivable that no recirculation or stirring takes place. The control unit 24 can further ensure that the third storage vessel 34 is filled with mineral water from the first storage vessel. To this end, the valves 78 and 84 are closed, and the valve 56 is opened. Thus, mineral water from the first storage vessel 4 is supplied to the recirculation system 44. This mineral water is then squirted by the pump 58 into the third storage vessel 34. When the float 60 indicates that the storage vessel is filled until the desired predetermined value, the float 60 operates the switch 62 which communicates with the control unit 24. The control unit 24 then stops the supply of mineral water from the first storage end to that third storage vessel. If the third storage vessel is much larger than the first storage vessel, the first storage vessel may, when the first storage vessel is empty, be filled with mineral water that is prepared on the basis of tap water and the minerals stored in the second storage vessel, discussed above. With this, the third storage vessel 34 can be filled further from the first storage vessel 4. If desired, this process can be repeated a number of times until the third storage vessel 34 is filled.

When the third storage vessel 34 is filled, the control unit 24 ensures that the recirculation device 44 is active. As a result, via conduit 46, mineral water is pumped out of the third storage vessel and then pumped back via the recirculation outlet 50. Here, the water squirts against the inner wall 66 of the third storage vessel. In this example, the mineral water squirts from the recirculation outlet 50 vertically upwards against a spherical upper side 93 of the third storage vessel 34 (see FIG. 3). FIG. 3 shows that the whole third storage vessel 34 is of transparent design. The vertical mineral water jet from the recirculation outlet 50 is denoted by reference numeral 95. Periodically, the second recirculation device 80 is put into operation. The cold water contained in the conduits 38, pump 40 and filter 42 will gradually warm up. To keep the water in the conduit 38 cool, valve 84 is periodically opened while valves 56 and 87 remain closed so that the warmed-up water contained in the conduit 38 is returned to vessel 4 and replaced by cold water from vessel 4. Simultaneously, also, the water is filtered over filter 42 to remove undesirable constituents from the water such as algae, microbes or flavourings or colorants. The filter may therefore be provided with a microfilter such as a capillary membrane or a ceramic filter or a carbon filter. A combination of a micro filter and a carbon filter is possible too. To prevent, for instance, growth of bacteria, energy loss and/or formation of condensation, this filter or combination of filters can also be included in the first storage vessel since this vessel is cooled.

When a user opens the first outlet 36, a cup placed on the platform 72 is filled with cooled mineral water coming from the first storage vessel. As a result, the level of the water in the first storage vessel will sink, which is detected by means of the float 94 after which the first storage vessel can be refilled with tap water and minerals as described hereinbefore. The user, for that matter, obtains the impression that he taps water coming from the third storage vessel 34.

If however, a user wishes to consume uncooled mineral water, he can open the second outlet 68 for supplying uncooled mineral water from the third storage vessel to a holder situated on the platform 72. By means of the switch 62 it is detected that the storage vessel is not completely filled until the predetermined first level. The control unit 24 can then ensure that the third storage vessel is refilled from the first storage vessel. However, it is also possible that the third storage vessel is refilled only if the mineral water level has sunk to below a predetermined second level which is lower than the first level. To this end, the third storage vessel can be provided with a second float/switch combination. The water level is then always situated between the first and second predetermined level. Accordingly, also the first storage vessel can be provided with a second float/switch combination so that the water level in the first storage vessel is also refilled until a third predetermined level when this level sinks to a fourth predetermined level which is lower than the third predetermined level. Periodically, the contents of vessel 34 can be cooled and cleaned by recirculating a portion of the contents of vessel 34 via valve 78 to vessel 4. Via the recirculation system 80, conduit 54 and conduit 58, cold water from vessel 4 is then returned via filter 42 to vessel 34. This has the advantage that, periodically, the water in vessel 34 is cleaned from microbial contaminations or algae that may be present.

When it is desired to empty the third storage vessel 34, the valve 79 can be opened. Then, the mineral water flows from the third storage vessel to the first storage vessel. Optionally, an excess of mineral water may be discharged from the first storage vessel via the overflow 86.

In this example, the apparatus is further provided with a wastewater tank 100 in which mineral water that flows out of the first storage vessel via the overflow 86 is collected.

Further, water flowing away from the platform 72 via duct 90 is collected in this storage tank 100. The storage tank is further provided with a dirt filter 102 and an overflow 104 for discharging waste water when the level of the wastewater in the storage tank 100 exceeds a predetermined value. Furthermore, the waste tank 100 includes a float 106 which operates a switch 107. The switch 107 energizes a pump 108 for discharging wastewater from the tank 100 when the float rises above a predetermined value. This wastewater is supplied under pressure to a conduit 110 which discharges, for instance, in the sewer. The conduit 110 likewise communicates via a conduit piece 112 with the filter 10 for discharging waste materials from the filter 10 to the sewer.

FIG. 4 schematically shows a second possible embodiment of an apparatus according to the invention. In FIGS. 1 and 4, parts corresponding with each other are provided with the same reference numerals.

In the second embodiment, it holds that the first fluid connection 6 is provided with a conduit 140 which extends from the inlet 2 to the first recirculation system 44 and a conduit 74 which extends from the first recirculation system 44 to first storage vessel 4. The first fluid connection then also comprises a part of the first recirculation system 44 (situated between the points of connection of the conduit 140 with the first recirculation system 44 and the conduit 74 with the first recirculation system 44).

When starting up the apparatus, the tap water flows via the conduit 140, a part of the first recirculation system 44 and a conduit 74 when a valve 120 is opened, from the tap water inlet 2 to the first storage vessel 4 and, optionally, to the third storage vessel 34. This means that the first fluid connection then extends from the inlet 2 to the first storage vessel 4. Therefore, the first fluid connection included between the tap water inlet 2 and the first storage vessel 4 is, in this case, formed by the conduit 140, a part of a conduit 141 of the first recirculation system 44, the conduit 74 and the outlet 78. Arranged in the conduit 140 is a filter 10 in a downstream position of the tap water inlet 2. Preferably, this filter comprises a reverse osmosis (RO) filter. Furthermore, a non-return valve 129 is included between the tap water inlet 2 and the RO-filter 10. Arranged between the tap water inlet 2 and the non-return valve 129 is the tap 2a. Preferably, a dirt water filter 10a is included between the RO filter 10 and the return valve 129. The conduit 141 connects to conduit 74 which discharges by means of an outlet 78 in the first storage vessel 4. The conduit 140 further includes a flow meter or volume meter 121. The conduit 74 comprises a tap or valve 120. The first storage vessel 4 contains a float with a switch 126. The float 126 with the switch is provided with three positions, that is to say: a lower position at a low level of the water in the first storage vessel 4; a higher position at a high level of the water in the first storage vessel 4; and a middle position which applies when the water assumes a level between the highest and lowest level.

The switch 126 communicates with the control unit 24. When the switch 126 assumes the lowest position, the control unit 24 ensures that the valve 120 is open. This takes place when starting up the apparatus when the apparatus is filled with the tap water. The tap water is, in that case, supplied via the first fluid connection to the first storage vessel 4, at least until the switch 126 assumes a position located between the lower and higher position.

In this embodiment, the flow or volume meter 121 communicates with the control unit 24. On the basis of a predetermined amount of water measured by the meter 21, the control unit ensures that the dosing unit 18 dispenses minerals from the second storage vessel 16 to the first storage vessel 4. This embodiment, too, is provided with a cooling unit 20 for cooling the first storage vessel 4. Furthermore, this embodiment, too, is provided with a third storage vessel which, in use, is filled with mineral water. The apparatus is further provided with a second recirculation system 80 for discharging mineral water from the first storage vessel 4 and for then supplying the discharged mineral water to the first storage vessel 4 again.

This apparatus is further provided with a second fluid connection between the first storage vessel 4 and the third storage vessel 34 for conveying the mineral water from the first storage vessel 4 to the second storage vessel 34. The second fluid connection comprises the conduit 38, a part of the conduit 54 and a part of the conduit 141. In this embodiment, the second fluid connection is therefore formed by a part of the second recirculation system 80, a part of the first recirculation system 44 and the recirculation outlet 50. The second fluid connection therefore extends at least partly through at least a part of the first recirculation system. The second recirculation system 80 includes the conduit 38 which is connected with the first storage vessel 4. The conduit 38 further includes a pump 40 and a filter 42. From the conduit 38, via a valve 122, water can arrive in the first recirculation system 44 from where the mineral water can flow to the recirculation outlet 50 to thus arrive in the third storage vessel 34. In other words, the second recirculation system comprises the conduit 38, a part of the conduit 141, the conduit 54 and the conduit 74. The second recirculation system 80 therefore comprises a part of the first recirculation system 44. It therefore also holds that the second fluid connection extends through at least a part of the second recirculation system. The apparatus also comprises an outlet for dispensing mineral water from a third storage vessel 34 and/or the first storage vessel 4.

In the embodiment shown in FIG. 4, outlet 36 forms the outlet for dispensing mineral water from the first storage vessel, and outlet 68 forms the outlet for dispensing mineral water from the third storage vessel 34. The first recirculation system 44 is also suitable for discharging mineral water from the third storage vessel 34 and for adding, via conduit 74 when a valve 120 is open, the discharged mineral water to the third storage vessel 34 again. Thus, a fifth fluid connection is present, formed by the conduit 54, the conduit 141, the conduit 74 and the outlet 78, which extends from the third storage vessel to the first storage vessel. In fact, the conduit 74 forms a sixth fluid connection extending from the first recirculation system 44 to the first storage vessel 4.

The apparatus is, in this embodiment too, provided with a third fluid connection between the first storage vessel 4 and a first outlet 36 of the at least one outlet for dispensing cooled mineral water form the first storage vessel 4. The third fluid connection is formed by conduit 38 in which, in this case, pump 40 and filter 42 are included. Outlet 68 is connected, via a fourth fluid connection, with the third storage vessel 34 for dispensing mineral water from the third storage vessel 34. The fourth fluid connection is formed by conduit 69. The apparatus is, as stated, also provided with a fifth fluid connection between the third storage vessel 34 and the first storage vessel 4 for conveying mineral water from the third storage vessel 34 back to the first storage vessel 4. The fifth fluid connection is, in this case, formed by conduit 54, conduit 141, conduit 74 and outlet 78. In this case, too, the second recirculation system 80 can be used to discharge mineral water from the first storage vessel 4 and to subsequently supply the discharged mineral water to the first storage vessel 4 again. In fact, from the second recirculation system 80 the water can flow via valve 122 into the first recirculation system. In other words, as already stated, the first recirculation system is connected with the second recirculation system. Via conduit 74 and outlet 78, the water can arrive in the first storage vessel 4 again. The embodiment of the apparatus shown in FIG. 4 can be provided with a conduit 150 and a valve 152 included therein which extends between the third storage vessel 34 and the first storage vessel 4 or, in the example shown, extends from the third storage vessel 34 to the conduit 74 between the valve 120 and the first storage vessel 4. Via conduit 150 and via conduit 74, it is possible to allow tap water to flow from the inlet 2 to the first storage vessel 4. This can take place, for instance, when starting up the apparatus. When using conduit 74 when the valve 120 is open, the tap water flows from the inlet 2 via conduit 140 to second recirculation system 80 to subsequently arrive via pump 58 and conduit 141 through the then opened valve 120 in conduit 74. When using conduit 150, the tap water then flows from the inlet 2 via conduit 140 to the first recirculation system 82 and subsequently arrives via pump 58, conduit 141 and recirculation outlet 50 in the third storage vessel 34. From the third storage vessel 34 the tap water flows via conduit 150 with the valve 152 then open therein into the conduit 74 and subsequently arrives in the first storage vessel. Functionally, in such a situation, the conduit 150 and 74 also form part of the first fluid connection which in fact extends from the inlet 2 to the first storage vessel 4. This situation can also occur when, during use, the level of the water in the first storage vessel 4 is very low as a result of, for instance, excessive use of the apparatus, repair, cleaning etc. In normal use, it is possible that tap water arrives via conduits 74 and/or 150 in the first storage vessel although the tap water will then be mixed with, for instance, mineral water flowing in the first recirculation system 44.

The conduits 74 and 115 are also useful for supply of mineral water to the first storage vessel, for instance in a situation in which no tap water is supplied to the apparatus via the inlet 2 and the position of the float 126 in the first storage vessel indicates that water must be added to the first storage vessel. In this case, the valve 152 of the conduit 150 too will be controlled by means of the control unit 24 on the basis of the position of the float 125.

As stated before, it is of course possible that conduit 140 does not discharge in conduit 74 but discharges directly in the first storage vessel 4. Conduit 150 may functionally form part of the second recirculation system, which second recirculation system is therefore connected with the first recirculation system. The other characteristics of the embodiment shown in FIGS. 1, 2 and 3 will also apply for the embodiment shown in FIG. 4.

The embodiment shown in FIG. 4, after starting up, operates as follows. When mineral water is taken from the apparatus for instance by allowing an amount of mineral water to flow from outlet 68, the float 125 provided with a switch will detect this taking. This switch 125 also communicates with the control unit 24 which opens the tap 2a on the basis of this detection. The tap water flows, via non-return valve 129 through the dirt filter 10a to the RO-filter 10. The wastewater from the RO-filter is discharged via conduit 112 and conduit 110. The filtered water arrives via conduit 140 in the first recirculation system 44. It holds that via the conduit 140 tap water is supplied to the first recirculation system, which is then filled with mineral water. This means that the first fluid connection, in this embodiment, also extends from the outlet 2 to at least the first circulation system. When it is detected that mineral water has been taken from the third storage vessel 34, the filtered water will, in the first instance, arrive in the third storage vessel 34 via a recirculation outlet 58. Pump 58 provides the required pressure. When the switch 125 in the third storage vessel 34 has reached a desired level the tap 2a is closed again.

After a predetermined amount of water has optionally been measured continuously by the flow or volume meter 121, the control unit 24 ensures that the valve or tap 122 opens. The mineral water coming from the first storage vessel 4 is then admixed to the water flowing through the first recirculation system 44. A part of the water which flows through the first recirculation system can flow to the first storage vessel by opening the valve 120. By opening the valve 152, too, water can flow from the third storage vessel to the first storage vessel. Thus, via the first and second circulation circuits, the water can be properly mixed so that the concentration of the mineral signal water becomes equal the same everywhere. If this concentration is too low, minerals can be supplied from the second storage vessel 16 to the respective water by means of the dosing unit 18. After mixing, the concentration of all the water will rise to the desired level.

It will be clear that the supply of minerals to the first storage vessel is also understood to mean the supply of minerals to other points in the apparatus from which the water can flow to the first storage vessel 4. Here, adding minerals to for instance the first fluid connection, the first recirculation system 44, the second recirculation system 80 or the third storage vessel 34 can be involved.

Preferably, all fluid connections with the third storage vessel extend from the housing 65 through the support 70. As a result, all fluid connections are invisible to a user.

The cooling of the mineral water in the first storage vessel 4 can, for instance, be regulated on the basis of the position of the float 126 and/or a temperature measurement of that water. Such regulations are adjustable by those skilled in the art in a simple manner.

The circulation of the water in the first recirculation system 44 can take place on the basis of the position of the float 125 in the third storage vessel 34. Thus, for instance, the pump 58 can be put into operation when the float 125 has reached the lower position. These regulations, too, are adjustable by those skilled in the art in a simple manner

The invention may be arranged such that when an amount of water predetermined by the meter 121 is not measured per prolonged time unit of, for instance, a day, the water from the water tank 100 is pumped away and fresh tap water is supplied to the water processing means from the tap water inlet 2. In the embodiment shown in FIG. 4, too, it holds that each fluid connection extending from the housing to the third storage vessel or the first outlet is shielded from vision, and it holds that the first storage vessel, the second storage vessel, the cooling unit, and the dosing unit are shielded from vision. A user will therefore always have the impression that water is taken from the third storage vessel, even though water is taken from the first storage vessel.

A water supply apparatus of an assembly according to the invention is not limited in any manner to the embodiment outlined hereinabove. Thus, the first, second, third, fourth, fifth, and sixth fluid connections may also be formed by other systems of conduits. Also, one of the outlets 36 or 38 may be omitted so that only cooled or only uncooled water can be taken. Moreover, both outlets may be combined to one outlet. For cooling, each known per se cooler can be used. In the embodiment of FIG. 1, the first recirculation system and the second recirculation system may be connected with each other by opening the valve 79. If the first and the second recirculation system are in use, all the water in the apparatus can thus be properly mixed so that a homogeneous concentration can be obtained. The water in the third storage vessel can then also be cooled by water coming from the first storage vessel. This also applies to the embodiment of FIG. 4 when the valve 120 and/or the valve 152 is open. The apparatus will then further be provided with one or two valves for optionally supplying mineral water from the first storage vessel 4 or from the second storage vessel 34 to the respective one outlet. This choice may, for instance, be made by a consumer by means of an electronic switch, after which, by opening the one outlet, mineral water is dispensed from the first or the third storage vessel. The apparatus may further be provided with, for instance, an opto-coupler 110, with which it can be detected whether there is a second storage vessel 16 which is coupled with the dosing device 18. The second storage vessel 16 may, for instance, be of interchangeable design. The second storage vessel 16, however, need not often be interchanged because it can be provided with sufficient minerals for preparing hundreds of liters of mineral water. The apparatus may further be provided with conductivity meters, for instance in vessel 4, to control the quality of the cold water system or after filter 10 to control the operation of the filtering device. Thus, the filter 42 may also be included in the conduit 46, that is to say in the first recirculation system. Also, besides the filter 42 in the conduit 38, a filter may also be included in the first recirculation system. In that case, the first and the second recirculation system each comprise a filter. These filters may be of the type as mentioned in the present application, but also other known per se filters suitable for filtering water are useful. These filters may each be provided with, for instance, a microfilter, such as a capillary membrane, a ceramic filter, a carbon filter, etc. for, for instance, removing undesirable constituents from water, such as algae, microbes, odorants, flavorings, and the like. Also a combination of a micro filter and a carbon filter is possible, and to prevent bacterial growth, energy loss and/or condensation, this combination may for instance be placed in the first storage vessel 4. The fact is that storage vessel 4 is cooled. The apparatus may also be used to prepare fruit juice which may be realized by mixing the mineral water and a concentrate of fruit juice. It is possible that the concentrate is put into a beaker separately before the mineral water is added. It is also conceivable that near the first outlet and the second outlet a provision is made for dissolving in the mineral water a fruit juice concentrate or separately dispensing a fruit juice concentrate The apparatus is, in use, preferably washed so often by activation of the pumps that the growth of microorganisms is practically completely avoided.

Also, if desired, the second recirculation system may be omitted. In that case, it is also possible that no stirrer needs to be used in the first storage vessel when minerals are used that rapidly and easily dissolve in water.

With apparatus as discussed hereinabove, many parts can be understood to be water-processing parts. Parts which, in the water supply apparatus, directly contact the water which is suitable for consumption or is made suitable for consumption, can be understood to be water processing means. The second storage vessel 16, which is, for instance, filled with a viscous mineral concentrate or with minerals in (dry) powder form, and the dosing unit 18 cannot be counted as water processing means in the above-described examples. The control unit 24 controls, in particular, valves and pumps and hence the flow of water in the water supply apparatus. To that end, the control unit 24 is provided with a water-processing program for carrying out the operation of the apparatus as, for instance, described hereinabove.

FIG. 5 schematically shows an example of a cleaning system RS which is suitable for cleaning a water supply apparatus provided with a tap water inlet and a mineral dosing unit with the aid of which, on the basis of on tap water, mineral water can be generated. Such a water supply apparatus is also provided with water processing means and a control unit. This control unit is designed for controlling, according to a predetermined water supply program, at least a part of the water processing means for the purpose of presenting mineral water. Examples of such a water supply apparatus are described hereinabove. In FIG. 5, with reference numeral 1, a further part of such a water supply apparatus is shown. In FIG. 5, the cleaning system is referred to with reference RS. The cleaning system is provided with a cleaning agent vessel H from which, in use, cleaning agent can be supplied to the water supply apparatus. The cleaning system is further provided with a cleaning system control unit BE arranged to control at least a part of the water processing means according to a predetermined cleaning program, for the purpose of cleaning at least a part of the water processing means. The cleaning system control unit BE shown in FIG. 5 can be connected with the control unit 24 of the water supply apparatus. In this example, the control unit BE is provided with an electric connection comprising a communication plug G that can be connected with a connecting port (not shown) of the control unit 24 of the water supply apparatus 1. It is also possible that the cleaning system control unit BE is integrally connected with the control unit 24 of such a water supply apparatus. This will be the case, in particular, in a situation in which the cleaning system and the water supply apparatus are integrally connected with each other, that is to say, the cleaning system can be integrated in the water supply apparatus.

The cleaning system RS is also provided with a water inlet WI for taking in water.

Preferably, as shown, the water inlet WI can be connected, or has been connected, with the water supply apparatus 1 such that in use, water can flow from the water supply apparatus into the water inlet WI. This offers the advantage that the water inlet need not be connected, separately and directly, with a supply source of the tap water. In the embodiment shown of the cleaning system RS, the water inlet WI is connected with the water supply apparatus 1 downstream of the tap water inlet, or mains water inlet 2. In this example, the water inlet WI of the cleaning system is connected with a coupling piece A. The coupling piece A is included in a conduit between a non-return valve 129 and a position D in the conduit. With normal use of the water supply apparatus, so-called reserve osmosis (RO) filters are present at the position D. The coupling piece A is situated at a position where, with normal use of the water supply apparatus, a dirt filter 10a is included. As will be explained further, during cleaning of the water supply apparatus, a dummy RO-filter can be situated at position D. The real RO-filters can also be cleaned in the cleaning system during cleaning of the water supply apparatus.

The cleaning system RS is further provided with at least one cleaning agent outlet RMU which can be connected, or has been connected, with the water supply apparatus for supplying, during use, cleaning water to the water supply apparatus for the purpose of cleaning at least a part of the water processing means. The cleaning agent outlet can also comprise a hose that can be connected with the coupling piece A. The coupling piece A is designed such that when the water inlet WI and the cleaning water outlet RWU are connected with the coupling piece A, tap water coming from the non-return valve 129 will flow into the water inlet instead of proceeding to flow to position D of the water supply apparatus. The cleaning agent flowing into the coupling piece A via cleaning agent outlet RMU will flow in the direction of position D of the water supply apparatus. In this case, upstream of the water processing means, the cleaning agent outlet RMU of the cleaning system RS is connected with the water supply apparatus 1. In this case, the tap water inlet 2 and tap 2a and non-return valve 129 are not counted among the water processing means.

The water supply apparatus 1 is provided with an outflow from which the water supply apparatus can empty. The cleaning system RS is provided with an outflow inlet UI for taking in liquid which flows, in use, out of the outflow. Preferably, the outflow is situated at a lowest position of all positions where water can be contained in the water supply apparatus. This may, for instance, be at the bottom of the first storage vessel 4. A tap may be included in the outflow which is controlled by the cleaning system control unit BE. The water supply apparatus is further provided with a water outlet conduit WUL for allowing water to flow towards a discharge conduit 110 for the discharge of water. The cleaning system RS is further provided with a dispensed-water outlet conduit AWU which can be connected with the water outlet conduit WUL of the water supply apparatus 1 for discharging, during use, water dispensed by the water supply apparatus 1 which is withdrawn by the cleaning system from the water supply apparatus. In this case too, a connecting hose can be involved which is connected from the cleaning system with the water supply apparatus at position B. Optionally, a non-return valve B1 can be included between position B and the water outlet conduit WUL.

The water supply apparatus 1 can further be provided with a circulation system for circulating water as discussed in the description of an example of the water supply apparatus.

The cleaning system is further provided with a water purification device WZI and a purified-water outlet GWU for purifying water or allowing pure water to flow from the cleaning system, respectively. The purified water outlet GWU can be connected, or has been connected, with the water dispensing outlets 36, 38 of the water processing means. It is noted that the cleaning system can also comprise an auxiliary part (not shown) for keeping the water dispensing outlet 36, 38 open when the dispensed-water inlet AWI has been connected with this water dispense outlet 36, 38.

In the example 3 shown, the water purification device comprises RO-filter I. In such RO-filters, water flows that is to be purified. From such RO-filters, two water flows exit, i.e. pure water and wastewater. Furthermore, the water purification device is connected with the dispensed-water outlet AWU for discharge of wastewater from the water purification apparatus. Furthermore, the water purification apparatus is connected with the water inlet WI for supply of water to the water purification apparatus. The water purification apparatus WZI can, for that matter, also be connected with the cleaning agent outlet, optionally via the cleaning agent vessel H for discharging, optionally in an initial phase of the cleaning process, purified water together with the cleaning agent.

The cleaning system control unit is also designed for controlling the cleaning system. Preferably, the cleaning system control unit is provided with a display and instruction means such as a keyboard for representing instructions or giving instructions, respectively, such as, for instance, a start command. Moreover, by means of the display, error messages that may be detected by the cleaning system control unit BE can be communicated to a user.

The water supply apparatus 1 is further provided with a first terminal (not shown) for connection with an electric energy source and with a second terminal (not shown) with which the cleaning system can be connected so as to be connected with an electric energy source as well.

The cleaning system is provided with at least one filter holder FH in which at least one filter intended for the water supply apparatus can be included for, for instance, cleaning the filter. Reverse osmosis cartridges, in this example even three of such cartridges, can be included in the water purification device WZI. These cartridges may have been taken from position D of the water supply apparatus. For the purpose of cleaning the water supply apparatus, at position D, a so-called dummy RO filter can be included so that the pressure drop at that location is equal to a situation which applies during normal use of the water supply apparatus. Further parts of the cleaning system and, optionally, the water supply apparatus will be discussed with the possible operation of the cleaning system which presently follows for a situation in which the cleaning system is to be connected with the water supply apparatus for the purpose of cleaning the water supply apparatus.

In the following, parts of the water supply apparatus as well as of the cleaning system are discussed. In this example, the cleaning system RS is connected with a water supply apparatus 1 which corresponds to the example represented in FIG. 4.

A user of the cleaning system control unit 24 connects the communicating piece G of the cleaning system with the control unit 24 of the water supply apparatus 1.

Dirt filter 10a is removed from the water supply apparatus 1 and placed in the cleaning system at a position F. The coupling piece A is placed at the position where previously, the dirt filter was situated in the water supply apparatus. The RO-filter 10 is removed from the water supply apparatus 1 and placed either in the filter holder FH of the cleaning system or in the water purification device WZI. Dispensed-water outlet AWU of the cleaning system RS is connected with the water outlet conduit WUL of the water supply apparatus 1 at position B. The water inlet WI of the cleaning system is connected with coupling piece A of the water supply apparatus 1. Cleaning water outlet RWU of the cleaning system RS is connected with coupling piece A of the water supply apparatus 1. As discussed hereinabove, no direct flow of water is possible any longer between a conduit part located downstream relative to the non-return valve 129 and a conduit part located upstream relative to position D. The fact is that at the connecting piece A, water will flow into the water inlet WI and water and/or cleaning agent will optionally flow from the cleaning water outlet of the cleaning system RS into the connecting piece A such that the water or cleaning agent arrive at position D where, during cleaning, a dummy filter has been placed. The cleaning system RS is connected with the outflow inlet UI of the outflow (not shown) of the water supply apparatus. The purified-water outlet GWU of the cleaning system RS is connected with the water dispensing outlets 36, 68 of the water supply apparatus. An auxiliary part (not shown) is arranged such that the water dispensing outlets 36 and 68 are open. A new RO-filter to be placed in the water supply apparatus can be included in the filter holder FH instead of the RO-filter removed from the water supply apparatus 1. A new dirt filter may also be included at position F in the cleaning system. In the cleaning agent vessel H a predetermined amount of cleaning agent is poured. The cleaning agent can comprise hydrogen peroxide.

When a user has carried out the above-mentioned steps of the cleaning system RS, the cleaning system can carry out the job independently by means of the cleaning system control unit. The water processing means will then circulate the water or the cleaning agent m the water supply apparatus. Pump M aids the process by pumping until the water level in the storage vessel 4 has reached a relatively low position. Pump N switches on and remains in operation as long as there is cleaning agent to be pumped. The cleaning agent flows into the water supply apparatus 1 and is circulated there by means of the pumps 40 and 58 so that the cleaning system in the water supply apparatus travels a path which, normally, is travelled by the water. Preferably, the cleaning program is set such that at least virtually each position that contacts water contacts the cleaning agent as well. Hence, according to the cleaning program, for instance tap 134 can be opened for releasing conduit parts to the cleaning agent. The above-mentioned part of the cleaning program in which cleaning agent is circulated in the water supply apparatus should be followed by a predetermined flushing program as part of the cleaning program. A transition to the flushing program can be activated on the basis of, for instance, and amount of water already pumped, measured by a water meter, and/or on the basis of time.

To that end, the cleaning program also provides in filling the cleaning system RS with tap water. To this end, pump L switches on. Tap P may open so that this water flows through the cleaning system RS in an accelerated manner, thereby flowing through the filters included in the cleaning system. Preferably, the cleaning system RS is already filled with tap water while the cleaning agent is circulated in the water supply apparatus 1. In this example, after a predetermined period of time, the cleaning system control unit BE ends the operation of the pumps 58 and 40. Then, pump M starts pumping as long as the motor of the pump experiences resistance, therefore as long as there is liquid to be pumped. The cleaning agent is thereby pumped from the water supply apparatus 1. Pump M and the taps O and Q are activated until the water meter S has measured a predetermined number of pulses. The number of pulses is geared to the volume of the cleaning agent vessel H which, in this phase of the cleaning program, is filled with purified water.

For filling the water supply apparatus 1 with purified water, the pumps 40 and 58 are activated. Pump L and the taps O and R are activated until the water meter S has measured a predetermined number of pulses. The water supply apparatus is thus filled via the cleaning water outlet RWU and the purified water outlet GWU. The water supply apparatus is filled with pure water while the water processing means have been set such that the water supply apparatus is filled with purified water as quickly as possible. This part of the cleaning program is set such that each position the cleaning agent has flowed along will be flushed by purified water. The pump L keeps pumping and the taps O and R will remain open until the water level in the third storage vessel has reached the upper level. This situation is transmitted by float 125 with the aid of a signal to the cleaning system control unit BE, optionally via the control unit 24 of the water supply apparatus. The cleaning system control unit BE then sends a signal to pump 40 and, optionally also, pump 58 to stop pumping. Pump M is activated and pumps water from the water supply apparatus via the outflow inlet UI and the dispensed-water outlet AWI as long as the pump M takes up power. When pump M has no more water to pump, the taps O and R are reopened for a period of time in which water meter S has measured a predetermined number of pulses. Pump 40 and, optionally, also pump 58 are activated again. Pump N stops when the motor no longer takes up power, in other words, when there is no more water to be pumped. Pump L and the taps O and R are activated again or opened, respectively, until the float 125 in the third storage vessel 34 has reached the upper, predetermined level again. The above-described flushing program of the cleaning system is repeated for a predetermined number of times. This predetermined number of times will be based on experiments indicating that the cleaning agent in the water supply apparatus has diluted to a concentration of which it has been established that it is not detrimental to the health of a user of the water supply apparatus, and of which it has been established that it has no noticeable effect on the taste of the water. Finally, after the water supply apparatus has been filled for a last time, the cooling unit 20 and the dosing unit 18 are activated again. The water supply apparatus is then prepared for use.

It will be clear that adjustment of the various program parts in terms of periods of time during which particular pumps and particular taps are open, depends on the volume units and, for instance, the concentration of the cleaning agent.

It is possible to use the cleaning agent hydrogen peroxide. This may be diluted in advance or be diluted in the cleaning system by admixing water. Here, efforts can be directed to obtain an optimum concentration with which the cleaning agent operates effectively in a short period of time and, with a number of flushing operations carried out on the basis of the flushing program, can be diluted relatively rapidly such that the water supply apparatus is prepared for use again.

The display of the cleaning system control unit BE indicates the phase of the cleaning program the cleaning operation is in. When the cleaning program has ended and the water supply apparatus has been prepared for use again, it is optionally indicated that the connections GWU, UI, WI, RMU and AWU can be taken away and the water dispensing outlets 36, 68 can be closed again. Also, the coupling piece A can be replaced by the optionally cleaned dirt filter 10a.

Optionally, the display can also indicate error messages with suggestions for reasons why the cleaning program reports an error message. Afterwards, the communication plug G can be uncoupled from the control unit 24.

Many variants on the cleaning system and/or the cleaning program are possible. As already stated, it is possible that the cleaning system and the water supply apparatus are integrated in each other and, for instance, are situated in one housing. In this case, it is also possible that one control unit is involved that can function as control unit of both the water supply apparatus and the cleaning system control unit which is designed for controlling the cleaning system and the water supply apparatus for the purpose of cleaning the water supply apparatus. The control unit may likewise comprise a mechanical control unit. The outflow can also be arranged at a different, low position in the water supply apparatus. The embodiment described is directed to cleaning the water supply apparatus at very high speed. It is also possible that the cleaning takes place at a much lower rate, for instance during the night. In that case, the cleaning program can be designed differently and fewer connections between the water supply apparatus and the cleaning system could suffice. It is also possible that the cleaning system and/or the water supply apparatus be provided with measuring means for measuring for instance a concentration of cleaning agent still present in the water and, for instance, a concentration of bacteria still present. On the basis of these data the cleaning system control unit may adjust the cleaning program. Such embodiments are each understood to fall within the framework of the invention.

1. A cleaning system designed for cleaning a water supply apparatus which is provided with: a tap water inlet; a mineral dosing unit with the aid of which, on the basis of tap water, mineral water can be generated; water processing means and a control unit designed for controlling, according to a predetermined water processing program, at least a part of the water processing means for the purpose of presenting mineral water, the cleaning system being provided with at least one cleaning agent vessel from which, in use, cleaning agent can be supplied, directly or indirectly, to the water supply apparatus, characterized in that the cleaning system is provided with a cleaning system control unit designed for controlling at least a part of the water processing means according to a predetermined cleaning program for the purpose of cleaning at least a part of the water processing means.

2. A cleaning system according to claim 1, characterized in that the cleaning system control unit can be connected with the control unit of such water supply apparatus.

3. A cleaning system according to claim 1, characterized in that the cleaning system control unit is integrally connected with the control unit of such a water supply apparatus.

4. A cleaning system according to claim 1, characterized in that the cleaning system is also provided with a water inlet for taking in water.

5. A cleaning system according to claim 4, characterized in that the water inlet can be connected or has been connected with such a water supply apparatus such that in use, water can flow from the water supply apparatus into the water inlet.

6. A cleaning system according to claim 5, characterized in that downstream of the tap water inlet, the cleaning system can be connected or has been connected with the water supply apparatus.

7. A cleaning system according to claim 1, characterized in that the cleaning system is provided with at least one cleaning agent outlet which can be connected, or has been connected, with such a water supply apparatus for supplying, in use, cleaning agent to the water supply apparatus.

8. A cleaning system according to claim 7, characterized in that upstream of the water processing means, the cleaning agent outlet of the cleaning system can be connected, or has been connected, with such a water supply apparatus.

9. A cleaning system according to claim 1, characterized in that the cleaning system control unit is also designed for controlling the cleaning system.

10. A cleaning system according to claim 1, characterized in that the cleaning system is also designed for cleaning such a water supply apparatus which is also provided with a first terminal for connection with an electric energy source and with a second terminal with which the cleaning system can be connected so as to be connected with the electric energy source as well.

11. A cleaning system according to claim 1, characterized in that the cleaning system is provided with at least one filter holder in which, with the cleaning system in use, at least one filter intended for the water supply apparatus can be included for, for instance, cleaning the filter.

12. A cleaning system according to claim 1, characterized in that the cleaning system is provided with a water purification device and a purified-water outlet for purifying water or discharging purified water, respectively.

13. A cleaning system according to claim 12, characterized in that the cleaning system is also suitable for cleaning such a water supply apparatus which is further provided with a water dispensing outlet, while the purified-water outlet of the cleaning system can be connected with the water dispensing outlet of the water supply apparatus for filling, and optionally flushing, the water supply apparatus with water purified by the cleaning system.

14. A cleaning system according to claim 1, characterized in that the cleaning system is also designed for cleaning such a water supply apparatus which is further provided with a water outlet conduit for allowing water to flow to a discharge and that the cleaning system is provided with a dispensed-water outlet conduit which can be connected with the water outlet conduit for discharging, in use, water dispensed by the water supply apparatus.

15. A cleaning system according to claim 1, characterized in that the cleaning system is also designed for cleaning such a water supply apparatus which is further provided with an outflow from which the water supply apparatus can empty while the cleaning system is further provided with an outflow inlet for taking in a liquid which, in use, flows out of the outflow.

16. An assembly of a water supply apparatus and a cleaning system for cleaning the water supply apparatus, the water supply apparatus being provided with: a tap water inlet; a mineral dosing unit with the aid of which, on the basis of tap water, mineral water can be generated; water processing means and a control unit designed for controlling at least a part of the water processing means according to a predetermined water processing program, the cleaning system being provided with at least a cleaning agent vessel from which, in use, cleaning agent can be supplied, directly or indirectly, to the water supply apparatus, characterized in that the cleaning system is provided with a cleaning system control unit designed for controlling at least a part of the water processing means according to a predetermined water processing program, for the purpose of cleaning at least a part of the water processing means.

17. An assembly according to claim 16, characterized in that the control unit and the cleaning system control unit can be connected with each other.

18. An assembly according to claim 16, characterized in that the control unit and the cleaning system control unit are integrally connected with each other.

19. An assembly according to claim 16, characterized in that the cleaning system is also provided with a water inlet for taking in water.

20. An assembly according to claim 19, characterized in that the water inlet can be connected, or has been connected, with the water supply apparatus such that in use, water can flow from the water supply apparatus into the water inlet.

21. An assembly according to claim 16, characterized in that downstream of the tap water inlet, the water inlet of the cleaning system can be connected, or has been connected, with the water supply apparatus.

22. An assembly according to claim 16, characterized in that the cleaning system is provided with at least one cleaning agent outlet which can be connected, or has been connected, with the water supply apparatus for supplying, during use, cleaning agent to the water supply apparatus.

23. An assembly according to claim 22, characterized in that, upstream of the water processing means, the cleaning agent outlet of the cleaning system can be connected, or has been connected, with the water supply apparatus.

24. An assembly according to claim 16, characterized in that the cleaning system control unit is also designed for controlling the cleaning system.

25. An assembly according to claim 16, characterized in that the water supply apparatus is provided with a first terminal for connection with an electric energy source and with a second terminal with which the cleaning system can be connected so as to be connected with the electric energy source as well.

26. An assembly according to claim 16, characterized in that the cleaning system is further provided with at least one filter holder in which at least one filter intended for the water supply apparatus can be included for, for instance, cleaning the filter.

27. An assembly according to claim 16, characterized in that the cleaning system is provided with a water purification device and a purified-water outlet for purifying water or discharging purified water, respectively.

28. An assembly according to claim 27, characterized in that the water supply apparatus is provided with a water dispensing outlet while the purified-water outlet of the cleaning system can be connected with the water dispensing outlet for filling, and optionally flushing, the water supply apparatus with water purified by the cleaning system.

29. An assembly according to claim 16, characterized in that the water supply apparatus is provided with a water outlet conduit for allowing water to flow to a discharge, and that the cleaning system is provided with a dispensed-water outlet conduit that can be connected with the water outlet conduit of the water supply apparatus for discharging, in use, water dispensed by the water supply apparatus.

30. An assembly according to claim 16, characterized in that the water supply apparatus is provided with an outflow from which the water supply apparatus can empty, the cleaning system being further provided with an outflow inlet for taking in a liquid which, in use flows out of the outflow.

31. A cleaning system designed for cleaning a water supply apparatus which is provided with a tap water inlet, a mineral dosing unit with the aid of which, on the basis of tap water, mineral water can be generated, and water processing means, the cleaning system being provided with a water inlet and a cleaning agent vessel from which, in use, cleaning agents can be supplied to the water supply apparatus, characterized in that the water inlet can be connected, or has been connected, with the water supply apparatus such that in use, water can flow out of the water supply apparatus into the water inlet of the cleaning system.

32. A cleaning system according to claim 31, characterized in that downstream of the tap water inlet, the water inlet of the cleaning system can be connected, or has been connected, with the water supply apparatus.

33. A cleaning system according to claim 31, characterized in that the cleaning system is provided with at least one cleaning agent outlet which can be connected or has been connected with the water supply apparatus for supplying, in use, cleaning agent to the water supply apparatus.

34. A cleaning system according to claim 33, characterized in that, upstream of the water processing means, the cleaning water outlet of the cleaning system can be connected, or has been connected, with the water supply apparatus.

35. A cleaning system according to claim 31, characterized in that the cleaning system is also designed for cleaning such a water supply apparatus which is further provided with a first terminal for connection with an electric power source and with a second terminal with which the cleaning system can be connected so as to be connected with the electric energy source as well.

36. A cleaning system according to claim 31, characterized in that the cleaning system is provided with a filter holder, in which, with the cleaning system in use, at least one filter intended for such a water supply apparatus can be included for, for instance, cleaning the filter.

37. A cleaning system according to claim 31, characterized in that the cleaning system is provided with a water purification device and a purified-water outlet for purifying water or discharging purified water, respectively.

38. A cleaning system according to claim 31, characterized in that the cleaning system is also designed for cleaning such a water supply apparatus which is further provided with a water dispensing outlet, while the purified water outlet can be connected with the water dispensing outlet of the water supply apparatus for filling, and optionally flushing, the water supply apparatus with water purified by the cleaning system.

39. A cleaning system according to claim 31, characterized in that the cleaning system is also designed for cleaning such a water supply apparatus which is further provided with a water outlet conduit for allowing water to flow a discharge, and the cleaning system is provided with a dispensed-water outlet conduit which can be connected with the water outlet conduit for discharging water dispensed by the water supply apparatus.

40. An assembly of a water supply apparatus and a cleaning system for cleaning the water supply apparatus, the water supply apparatus being provided with: a tap water inlet; a mineral dosing unit with the aid of which, on the basis of tap water, mineral water can be generated; and water processing means, the cleaning system being provided with at least one cleaning agent vessel from which, in use, cleaning agent can be supplied, directly or indirectly, to the water supply apparatus, characterized in that the assembly is provided with at least one control unit designed for controlling at least a part of the water processing means according to a predetermined cleaning program for the purpose of cleaning at least a part of the water processing means.

41. An assembly according to claim 40, characterized in that the assembly comprises a control unit likewise designed for controlling the water processing means for the purpose of presenting mineral water.

42. An assembly according to claim 40, characterized in that the assembly comprises two control units, a first of the two control units, a cleaning control unit, being designed for controlling at least a part of the water processing means according to a predetermined cleaning program for the purpose of cleaning at least a part of the water processing means, a second of the two control units being designed for controlling the water processing means for the purpose of presenting mineral water.

43. An assembly according to claim 42, characterized in that the second control unit and the cleaning system control unit can be connected with each other.

44. An assembly according to claim 42, characterized in that the second control unit and the cleaning system control unit are integrally connected with each other.

45. An assembly according to claim 40, characterized in that the cleaning system is also provided with a water inlet for taking in water.

46. An assembly according to claim 40, characterized in that the water inlet can be connected, or has been connected, with the water supply apparatus such that, in use, water can flow from the water supply apparatus into the water inlet.

47. An assembly according to claim 40, characterized in that downstream of the tap water inlet, the water inlet of the cleaning system can be connected or has been connected with the water supply apparatus.

48. An assembly according to claim 40, characterized in that the cleaning system is provided with at least one cleaning agent outlet which can be connected, or has been connected, with the water supply apparatus for supplying, in use, cleaning agent to the water supply apparatus.

49. An assembly according to claim 48, characterized in that upstream of the water processing means, the cleaning agent outlet of the cleaning system can be connected, or has been connected, with the water supply apparatus.

50. An assembly according to claim 40, characterized in that the cleaning system control unit is also designed for controlling the cleaning system.

51. An assembly according to claim 40, characterized in that the water supply apparatus is provided with a first terminal for connection with an electric energy source and with a second terminal with which the cleaning system can be connected so as to be connected with the electric power source as well.

52. An assembly according to claim 40, characterized in that the cleaning system is further provided with at least one filter holder in which at least one filter intended for the water supply apparatus can be included for, for instance, cleaning the filter.

53. An assembly according to claim 40, characterized in that the cleaning system is provided with a water purification device and a purified-water outlet for purifying water or discharging purified water, respectively.

54. An assembly according to claim 53, characterized in that the water supply apparatus is provided with a water dispensing outlet while the purified-water outlet of the water supply apparatus can be connected with the water dispensing outlet for filling the water supply apparatus with water purified by the cleaning system.

55. An assembly according to claim 40, characterized in that the water supply apparatus is provided with a water outlet conduit for allowing water to flow to a discharge and the cleaning system is provided with a dispensed-water outlet conduit which can be connected with the water outlet conduit of the water supply apparatus for discharging, in use, water dispensed by the water supply apparatus.

56. An assembly according to claim 40, characterized in that the water supply apparatus is provided with an outflow from which the water supply apparatus can empty, the cleaning system being further provided with an outflow inlet for taking in a liquid which, in use, flows out of the outflow.
